(19) United States
(12) Patent Application Publication
(10) Pub. No.: US 2006/0230105 A1
(43) Pub. Date: Oct. 12, 2006

(54) Method of providing a remote desktop session with the same look and feel as a local desktop

(75) Inventors: Dan Shappir, Tel-Aviv (IL); Eran Heyman, Closter, NJ (US)

Correspondence Address: DR. MARK FRIEDMAN LTD.;c/o Bill Polkinghorn, 9003 Florin Way, Upper Marlboro, MD, 20772, US

(73) Assignee: ERICOM SOFTWARE B 2001 LTD

(21) Appl. No.: 11/398,544

(22) Filed: Apr. 6, 2006

Related U.S. Application Data
(60) Provisional application No. 60/668,589, filed on Apr. 6, 2005.

(51) Int. Cl. G06F 15/16

(52) U.S. Cl. 709/203

(57) ABSTRACT

In a client-server system, a method providing windows of applications running on server nodes the same look and feel as windows of applications running on a client node, and providing remote virtual desktops with the same look and feel as the local desktop on the client node, including: (a) providing server nodes; (b) providing applications running on the server nodes; (c) providing a remote presentation protocol for accessing the applications; (d) providing at least one client node displaying windows of the applications on a local desktop; (e) communicating, to the server nodes, status information regarding attributes of the local desktop, by operating a first software module on the client node, the attributes including representational attributes and/or behavioral attributes, and (f) receiving the status information from the client node and applying the status information to the applications running on the server nodes, by operating a second software module on the server nodes.

### CROSS REFERENCE TO RELATED APPLICATIONS

This application draws priority from U.S. Provisional Patent Application Ser. No. 60/668,589, filed Apr. 6, 2005.

### FIELD AND BACKGROUND OF THE INVENTION

The present invention relates to client-server computer networks. More specifically, the invention relates to a system and method for providing an integrated views of local and remote windows within a single desktop.

Recent years have seen a resurgence of server-based computing as a preferred model for application deployment, access and use. In server-based computing, applications are installed on a central server or multiple central servers and accessed from client nodes that provide only the display and user input functionality. The benefits of server-based computing include simplified application deployment and updates, the ability to use cheaper client devices, and improved security. The three main components that make up a server-based computing environment are:

1. One or more servers running a multi-user operating system.

2. A remote presentation protocol

3. Client software and device

Microsoft Windows has been traditionally a client-oriented platform, with applications running directly on the client-node, and having only a limited use of central resources, such as printers and file servers. The introduction of Microsoft Terminal Server as an effective implementation of a Windows-compatible multi-user operating system, coupled with introduction of remote presentation protocols, such as Microsoft Remote Desktop Protocol (RDP), have made server-based computing a viable solution

Because of the client-oriented tendencies and capabilities of modern operating systems, such as Windows itself, a mixed-model, or hybrid operation, is often desired rather than a pure server-based computing model. In such a mixed-model, some applications are run remotely on the server and other applications are run locally on the client. Benefits of this model include reduced load on the servers, reduced network traffic and the ability to use some applications when off-line (i.e., disconnected from the server). In order for such a model to be truly effective, the client software must be able to integrate windows of applications running on the server seamlessly into the client's desktop. Otherwise, the client user may become disoriented and frustrated from trying to navigate between applications running on the client's desktop and on a separate server desktop.

Another advantage of integrating the windows of the remote desktop into the client's desktop is in a scenario where a single client node is connected to multiple servers. Instead of server applications running in separate desktops, one per each server, they are all unified in the single local desktop, resulting in improved usability for the user.

The ability to integrate windows of applications running on the server into the client's desktop is known as “seamless windows”. Server applications accessed using the seamless windows mechanism emulate the behavior of local windows, creating a consistent look and feel for the user.

There is therefore a recognized need for, and it would be highly advantageous to have, a system and method that provide windows of remote applications with the same look and feel as the windows of local applications, and that provides remote virtual desktops with the same look and feel as the local desktop on the client node.

### SUMMARY OF THE INVENTION

The present invention is a system and method that provide windows of remote applications with the same look and feel as the windows of local applications, and that provides remote virtual desktops with the same look and feel as the local desktop on the client node. This is achieved by transferring the values of attributes that determine the look and feel of the local desktop to the server nodes, and applying these values, or equivalent values, in the context of the sessions that opened for that client node.

Most windowed environments make it possible for the user or administrator to customize the overall appearance and behavior of the desktop. These customizations include attributes such as color scheme, icons, fonts, system sounds, window shape, desktop background (wallpaper, pattern or color), mouse pointers, screen saver and more. These attributes are often collectively referred to as the desktop theme. By assigning remote virtual desktops the same theme as the local desktop, or as close a semblance as possible, more complete integration is achieved between the desktops.

In one aspect, the invention features a method that determines the values of the attributes of the local desktop, and transmits these values to the server when a connection is established between the client node and the server. On the server these values, or equivalent values, are applied to the appropriate attributes of the remote virtual desktop that is associated with that connection, resulting in the remote virtual desktop and windows of remote applications having the same look and feel as the local desktop, or as close as possible.

In another aspect of the invention, the attributes of the local desktop are monitored throughout the duration of the connection to the server. Changes to the values of the attributes that occur during the connection are detected and transmitted to the server. On the server this changes are applied dynamically so that the consistency between the remote virtual desktops and the local desktop is constantly maintained.

According to the teachings of the present invention there is provided, in a client-server system, a computer-implemented method providing windows of applications running on server nodes the same look and feel as windows of applications running on a client node, and providing remote virtual desktops with the same look and feel as the local desktop on the client node, the method including the steps of: (a) providing a plurality of server nodes; (b) providing a plurality of applications running on the server nodes; (c) providing a remote presentation protocol for accessing the applications; (d) providing at least one client node displaying windows of the applications on a local desktop; (e) communicating, to the server nodes, status information regarding a plurality of attributes of the local desktop, by operating at least a first software module on the client node, the attributes being selected from the group of attributes consisting of representational attributes (including visual and audio) and behavioral attributes, and (f) receiving the status information from the client node and applying the status information to the applications running on the server nodes, by operating at least a second software module on the server nodes.

According to further features in the described preferred embodiments, the server nodes are selected from the group of server nodes consisting of Microsoft Terminal Severs, Citrix Presentation Servers, and UNIX servers.

According to still further features in the described preferred embodiments, the remote presentation protocol is selected from the group of remote presentation protocols consisting of Microsoft Remote Desktop Protocol (RDP), Citrix Independent Computing Architecture protocol (ICA), X-Windows, and Virtual Network Computing (VNC).

According to still further features in the described preferred embodiments, step (f) includes operating components on the server nodes that receive the status information and apply it to the remote virtual desktops of the server nodes.

According to still further features in the described preferred embodiments, step (e) includes transmitting status information regarding at least one of a plurality of visual and behavioral attributes of the local desktop, the plurality including: color scheme, font settings, window shape and structure attributes, mouse pointer shapes and animations, menu effects and animations, and system sounds.

According to still further features in the described preferred embodiments, step (e) includes transmitting status information regarding the desktop locale settings, the status information including at least one format of the group consisting of date format, time format, and currency format.

According to still further features in the described preferred embodiments, step (e) includes transmitting status information regarding accessibility options, including at least one of the group consisting of displaying visual notifications for system sounds, sticky keys, and a color scheme appropriate for people with color blindness

According to still further features in the described preferred embodiments, step (e) includes transmitting status information regarding the behavior of file folder windows and file and folder selection dialogs, the behavior including at least one of the group consisting of: single-click or double-click to activate items, show or hide hidden or system files or folder contents and extensions for known file types, navigate in new or same window, and color code or underline file or folder names.

According to still further features in the described preferred embodiments, in step (e), values of the plurality of visual and/or behavioral attributes are read on the client node before a connection to the server nodes is established.

According to still further features in the described preferred embodiments, in step (e), values of the plurality of visual and/or behavioral attributes are read on the client node when a correction to the server nodes has been established.

According to still further features in the described preferred embodiments, the method further includes the step of: (g) monitoring changes in visual and/or behavioral attributes of the local desktop, by operating the first software module on the client node.

According to still further features in the described preferred embodiments, the changes that occur while the client node is connected to the server nodes are transmitted to the server nodes and applied on the server nodes.

According to still further features in the described preferred embodiments, if a value of the visual and/or behavioral attributes is not supported by the server nodes, the method further includes the step of: (g) approximating the value using a closest possible supported value.

According to still further features in the described preferred embodiments, the attribute is an audio attribute.

According to another aspect of the present invention there is provided, in a client-server system, a computer-implemented method providing windows of applications running on server nodes the same look and feel as windows of applications running on a client node, and providing remote virtual desktops with the same look and feel as the local desktop on the client node, the method including the steps of: (a) providing a plurality of server nodes; (b) providing a plurality of applications running on the server nodes; (c) providing a remote presentation protocol for accessing the applications; (d) providing at least one client node displaying windows of the applications on a local desktop; (e) communicating, to the server nodes, status information regarding at least one of a plurality of behavioral attributes of the local desktop, by operating at least a first software module on the client node, and (f) receiving the status information from the client node and applying the status information to the applications running on the server nodes, by operating at least a second software module on the server nodes

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are used to designate like elements.

In the drawings:

FIG. 1 is a diagram of the embodiment of a prior art server-based computing system, where the client nodes communicate with a server node over a network;

FIG. 2 is a diagram of the embodiment showing communication of look and feel attribute values between a software module on the client-node and a software module on the server-node;

FIG. 3 is a drawing showing how the windows of remote applications whose look and feel is not properly aligned with the local desktop do not integrate well into the local desktop, and

FIG. 4 is a drawing showing how the windows of remote applications whose look and feel is properly aligned with the local desktop do integrate well into the local desktop.

### DESCRIPTION OF THE PREFERRED EMBODIMENTS

The present invention is a system and method that provide windows of remote applications with the same look and feel as the windows of local applications, and that provide remote virtual desktops with the same look and feel as the local desktop on the client node.

The principles and operation of the system and method according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawing. The invention is capable of other embodiments or of being practiced or carried out in various ways. Also, it is to be understood that the phraseology and terminology employed herein is for the purpose of description and should not be regarded as limiting.

As used herein in the specification and in the claims section that follows, the term “client-side application” refers to an application that performs its computational logic using a CPU of the device providing its user interface.

As used herein in the specification and in the claims section that follows, the term “serer-based application” and the like refers to an application that performs its computational logic using a CPU of a device that is distinct from the device providing the user interface thereof. The device whose CPU is used for the computational logic is the server. Commonly, a server is able to perform the computational logic of multiple server-based applications in use by multiple users simultaneously.

As used herein in the specification and in the claims section that follows, the term “representational attribute” refers to a configuration or setting, provided by an operating system or a windowing system, which determines the methods in which various aspects of the user interface are presented to the user. These attributes specify the visual representation of the elements comprising the user's desktop and additional notification mechanisms such as sound. Representational attributes constitute the “look” aspect of configuration.

As used herein in the specification and in the claims section that follows, the term “behavioral attribute” refers to a configuration or setting, provided by an operating system or a windowing system, which determines the behavior of the user interface in response to user interaction. Each such setting determines one or more attributes of the behavior of the user interface, specifically the system's interpretation of user input and responses to such inputs, such as interpreting a single click on a desktop item as selecting the item or activating it. Behavioral attributes constitute the “feel” aspect of configuration.

Most modern operating systems and applications have graphical user interfaces (GUIs) that enable a computer display to be divided into several windows. Within each window, one can run a different program or display different data. Yet, despite this ubiquity, there is no universal, consistent standard that defines how windowed GUIs must look and behave in all their aspects. Standards, when they exist, are specific to a particular operating system or windowing system. Thus, windows of applications running on various operating systems will often look and feel different, even for an identical application.

In addition, most windowed GUIs provide numerous configurable attributes that allow the user or administrator to customize the look and feel of the environment. The collection of these attributes is sometimes referred to as the desktop theme. Users and administrators often modify the values for these attributes, thus replacing the system's default theme. There are numerous motivations for such modifications:
Assigning the desktops visual attributes that are consistent with the corporate image, e.g., placing the corporate logo on the desktop wallpaper;
Customizing the behavior of the desktop to facilitate use on a laptop that utilizes a touchpad instead of a mouse;
Giving the system a unique “personal” flavor;
Specifying accessibility options that allow the system to be used by people with various disabilities.

The result of the differences between various operating systems and windowing systems, and the differences that stem from customizations, is that distinct systems will often have a different look and feel. In a client-server environment, where a single client node displays the windows of applications running on multiple systems, a single desktop can have multiple windows, each having a distinctly different look and feel. Having two or more visual representations for the same items can confuse the user, or at the very least, interfere with the user's ability to easily associate a particular representation with a specific type of information or expected behavior.

The ability to customize the look and feel on a windowed GUI that can result in such inconsistencies can also be used to align the various systems with each other, thus increasing consistency. This customization can be performed manually via system dialogs and configuration files, or programmatically via the operating system's Application Programming Interface (API). The values of these attributes can also be determined programmatically, or by viewing the system configuration dialogs and files. Some operating systems also enable applications to receive notifications when the values of various attributes change. For example, on Microsoft Windows operating systems, shadows under menus can be enabled or disabled using the Display Properties dialog, under the Appearance tab, using the Effects settings. Shadows under menus can also be enabled or disabled using the Win32 API function System-ParametersInfo. The same function can also be used to obtain the current value of this setting. In addition, when this attribute is changed, Windows sends the WM_SETTINGCHANGE message to all top-level windows.

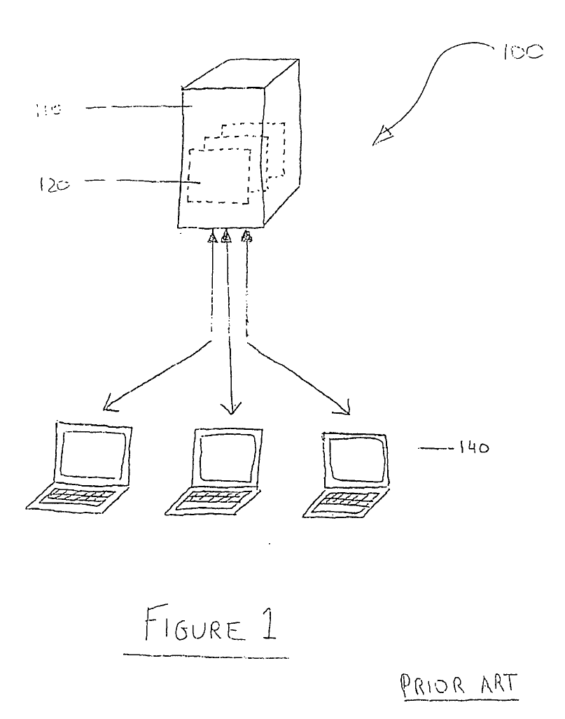

FIG. 1 is a schematic diagram of a prior art server-based computing system 100, wherein the client nodes communicate with a server node in a network. Client computing devices 140, each of which includes a keyboard, display, processing unit, and memory, maintain two-way communication with a terminal server 110 by means of a communication protocol such as RDP. Terminal server 110 produces an image of a virtual desktop 120 for each one of client devices 140. As terminal server 110 operates each given application (e.g., Microsoft Word, Adobe Acrobat), changes are made in each virtual desktop 120. The information is communicated to the respective client display devices 140, which then display the actual desktop for the user. Similarly, keystrokes, mouse inputs, etc., entered by the user of a particular client device 140 are communicated to terminal server 110, which then updates the corresponding virtual desktop 120.

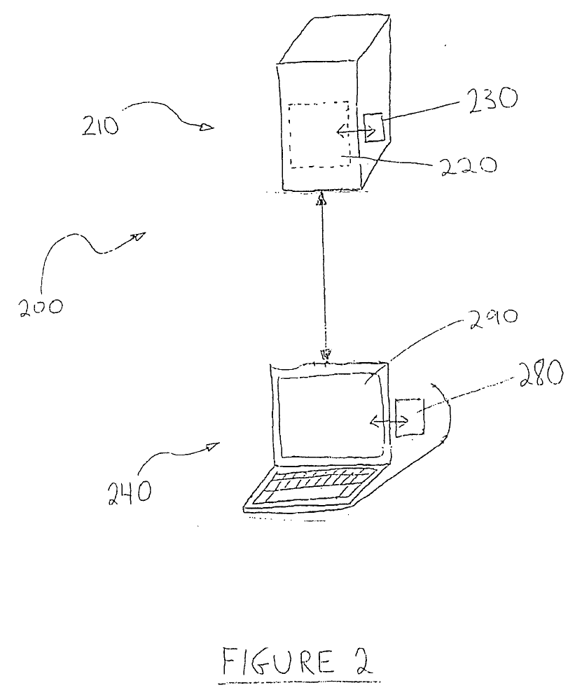

FIG. 2 is a schematic diagram of the inventive server-based computing system 200, which contains the basic components of prior art server-based computing system 100 described hereinabove, i.e., a plurality of client computing devices including client computing device 240, which includes a keyboard, display, processing unit, and memory, and a terminal server 210. Inventive server-based computing system 200 also makes use of the same communication protocols.

Terminal server 210 produces an image of a virtual desktop 220 for each client device 240. As terminal server 210 operates each given application, changes are made in virtual desktop 220. The information is communicated to is client device 240, which then displays the actual desktop for the user. Similarly, keystrokes, mouse inputs, etc., entered by the user of client device 240 are communicated to terminal server 210, which then updates the corresponding virtual desktop 220.

Inventive server-based computing system 200 further includes at least one software module 280 for reading the various look and feel settings of a local desktop 290, and making the updated settings available to a terminal server 210, and a software module 230 for receiving these look and feel settings, and subsequently applying these settings to a virtual desktop 220 of terminal server 210.

Preferably, an individual software module 280 is disposed within each one of client devices 240. It is also advantageous for software nodule 230 to be disposed within terminal server 210, as shown in FIG. 2.

In one preferred embodiment, software module 280, disposed within a particular client device 240, reads the various look and feel settings and transmits information pertaining to these settings to software module 230 disposed within terminal server 210. Typically, software module 280 is configured to detect changes in the look and feel settings.

Alternatively, a polling method is employed to retrieve information regarding the various look and feel settings according to pre-determined parameters, e.g., at a fixed time interval. Typically, the polling/data retrieval is initiated by software module 230. However, the polling can be performed by software module 280 and the results broadcast to terminal server 210.

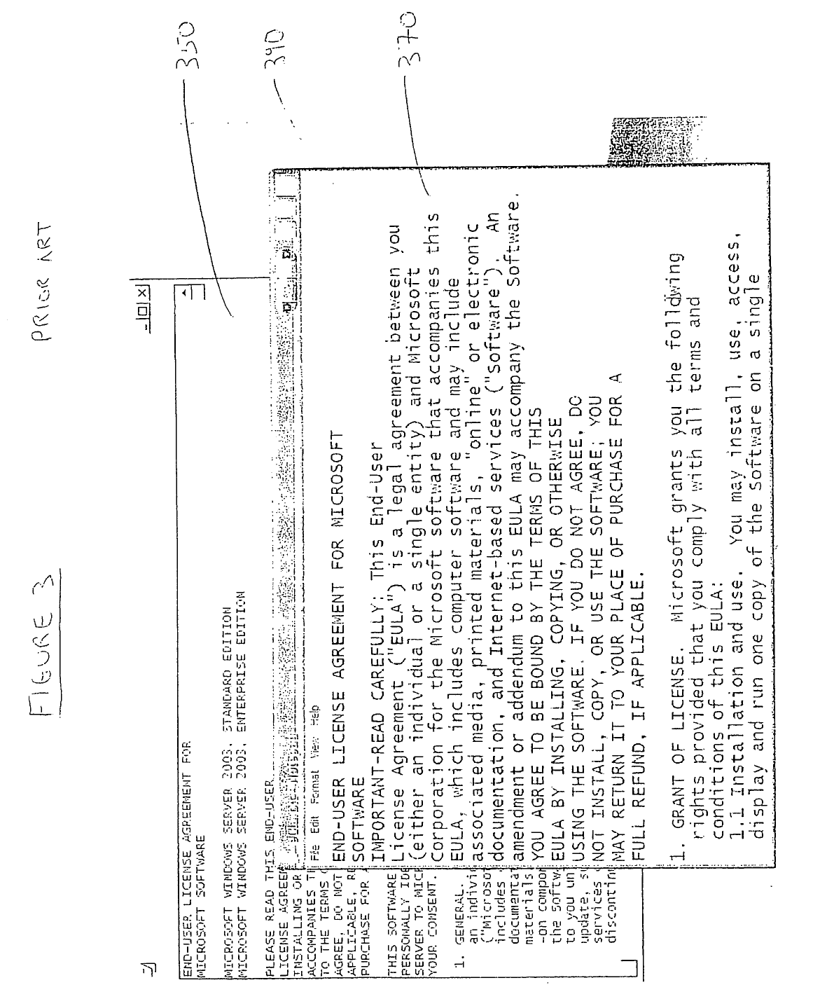

FIG. 3 shows a local desktop 390 having a remote application window 350 behind a local application window 370, according to the prior art. It will be appreciated that the look and feel of remote application window 350 markedly differs from look and feel of local application window 370. Although both windows are nominally windows of the Notepad application, by way of example, the fonts, window style, borders, window title bar are disconcertingly different.

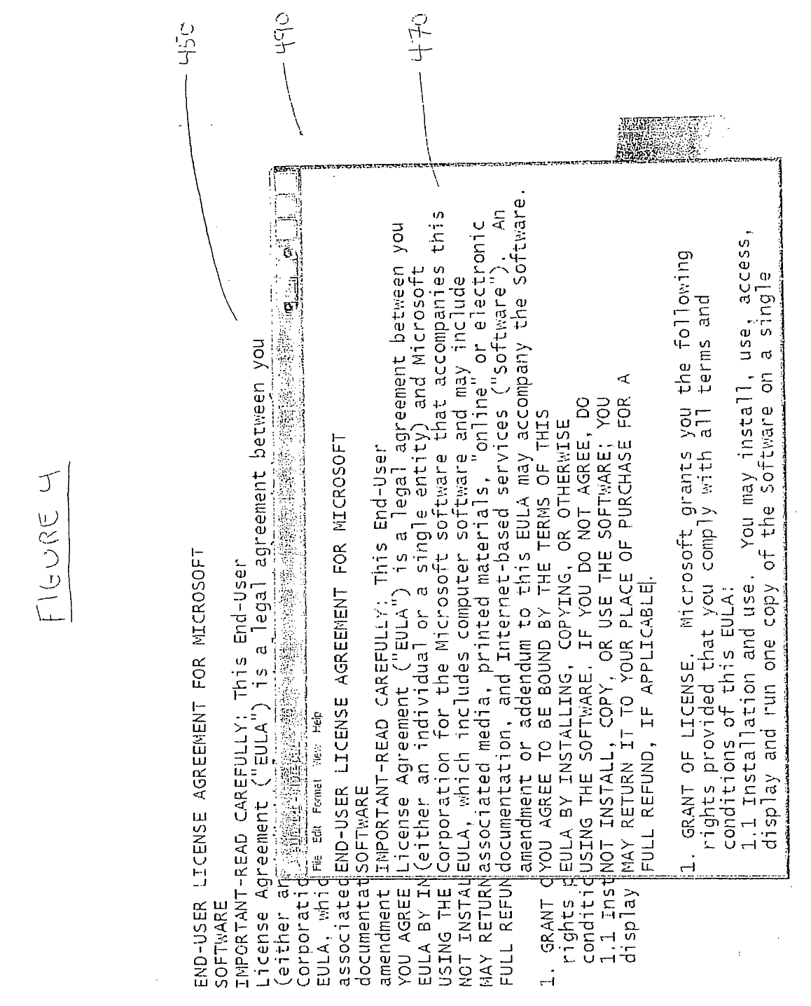

FIG. 4 shows a local desktop 490 having a remote application window 450 behind a local application window 470, according to the present invention. The fonts, window style, borders, window title bar are substantially identical. Similarly, all behavioral attributes associated with local desktop 490 are shared with the virtual desktop on the server, such that all look and feel attributes of local desktop 490 are imitated by the virtual desktop.

Many of the features described with respect to the figures will now be described in greater detail. In one preferred embodiment, the values of attributes that control the visual representation of elements that compose the local desktop are read programmatically before or during the establishment of a connection to a server. These values are transmitted to the server when the connection is established. A software module or component on the server receives these values and applies them to the remote virtual desktop or to specific windows of applications running on the server. Thus, the remote virtual desktop and windows of remote applications obtain the same visual representation as elements that compose that local desktop. Visual representation includes such attributes as color scheme, icons, fonts, window shape, element sizes (such as window title-bar) desktop background (wallpaper, pattern or color), mouse pointers, and animation effects.

In another preferred embodiment, the locale of the client desktop is transferred to the server. This allows remote applications to provide information and receive user input using the same locale as applications running on the client node so as, by way of example, to display date, time and currency consistently across all applications.

It must be emphasized that various aspects of the desktop theme have to do with non-visual aspects of the representation of elements that compose that local desktop. For example, various events may have a particular sound associated with them. On Microsoft Windows, the user or administrator can configure sounds that are played when an error occurs, a device is connected or disconnected, battery is low on a portable computer, a new email arrives, etc. It is particularly important that events related to remote applications generate the same sounds as the same events related to local applications. This is because the user learns to associate a particular sound with a specific event.

In one preferred embodiment, the identifiers of sounds that are associated with specific system events or application events are determined before or during the establishment of a connection to a server. The identifiers of sounds or the actual sound clip data are transmitted to the server when the connection is established. A component on the server receives these values and applies them to the remote virtual desktop or specific windows of applications running on the server. Thus, the remote virtual desktop and windows of remote applications utilize the same sounds for the same events as the local desktop.

Some aspects of the desktop theme have to do with behavior rather than representation. Behavior is the way in which the desktop interprets and responds to user interaction, such as the specification of whether desktop items are activated by a single mouse click or a double click. As such, behavior determines the feel of the desktop. Particularly important are those behavioral aspects that have to do with accessibility for people with disabilities, such as modifying keyboard behavior to allow typing using a single digit, and displaying visual warnings for system sounds for people with hearing disabilities.

In one preferred embodiment, the values of attributes that control the behavior of elements that compose that local desktop are read before or during the establishment of a connection to a server. These values are transmitted to the server when the connection is established. A component on the server receives these values and applies them to the remote virtual desktop or specific windows of applications running on the server. Thus, the remote virtual desktop and windows of remote applications behave the same as elements that compose that local desktop.

In another preferred embodiment, a component on the client continuously monitors the values of attributes that control the representation and behavior of elements that compose that local desktop. This monitoring is performed by listening for system notifications that are generated when values change, or by periodically polling attribute values. When one or more values change, the values are transmitted to the server. A component on the server receives these values and applies them to the remote virtual desktop or specific windows of applications running on the server.

When the a server does not support an attribute that is available on the client, or does not support a value that is available on the client for a particular attribute, other attributes and values will be used in order to create a similar or equivalent effect. For example, if the client desktop uses a particular font that is not installed on the server, applications on the server will be configured to use a different font from the same font family. This embodiment utilizes a technique—known in the art of Web browsers—for displaying an image that contains more colors than are available on the client, or for displaying text that uses a font that is not available on the client.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. In a client-server system, a computer-implemented method providing windows of applications running on server nodes the same look and feel as windows of applications running on a client node, and providing remote virtual desktops with the same look and feel as the local desktop on the client node, the method comprising the steps of:
(a) providing a plurality of server nodes;
(b) providing a plurality of applications running on said server nodes;
(c) providing a remote presentation protocol for accessing said applications;
(d) providing at least one client node displaying windows of said applications on a local desktop;
(e) communicating, to the server nodes, status information regarding at least one attribute of a plurality of attributes of said local desktop, by operating at least a first software module on said client node, said attribute being selected from the group of attributes consisting of representational attributes and behavioral attributes, and
(f) receiving said status information from said client node and applying said status information to said applications running on the server nodes, by operating at least a second software module on said server nodes.

2. The method of claim 1, wherein said server nodes are selected from the group of server nodes consisting of Microsoft Terminal Servers, Citrix Presentation Servers, and UNIX servers.

3. The method of claim 1, wherein said remote presentation protocol is selected from the group of remote presentation protocols consisting of Microsoft Remote Desktop Protocol (RDP), Citrix Independent Computing Architecture protocol (ICA), X-Windows, and Virtual Network Computing (VNC).

4. The method of claim 1, wherein step (f) includes operating components on said server nodes that receive and apply said status information to the remote virtual desktops of said server nodes.

5. The method of claim 1, wherein step (e) includes transmitting status information regarding at least one of said plurality of attributes of said local desktop, including: color scheme, font settings, window shape and structure attributes, mouse pointer shapes and animations, menu effects and animations, and system sounds.

6. The method of claim 1, wherein step (e) includes transmitting status information regarding the desktop locale settings, said status information including at least one format of the group consisting of date format, time format, and currency format.

7. The method of claim 1, wherein step (e) includes transmitting status information regarding accessibility options, including at least one of the group consisting of displaying visual notifications for system sounds, sticky keys, and a color scheme appropriate for people with color blindness.

8. The method of claim 1, wherein step (e) includes transmitting status information regarding a behavior of file folder windows and file and folder selection dialogs, said behavior including at least one of the group consisting of: single-click or double-click to activate items, show or hide hidden or system files or folder contents and extensions for known file types, navigate in new or same window, and color code or underline file or folder names.

9. The method of claim 1, wherein in step (e), values of said plurality of attributes are read on said client node before a connection to said server nodes is established.

10. The method of claim 1, wherein in step (e), values of said plurality of attributes are read on said client node when a connection to said server nodes has been established.

11. The method of claim 1, further comprising the step of:
(g) monitoring changes in said attributes of said local desktop, by operating said first software module on said client node.

12. The method of claim 11, wherein changes that occur while said client node is connected to said server nodes are transmitted to said server nodes and applied on said server nodes.

13. The method of claim 1, wherein if a value of said attributes is not supported by said server nodes, the method further comprises the step of:
(g) approximating said value using a closest possible supported value.

14. The method of claim 1, wherein said attribute is an audio attribute.

15. In a client-server system, a computer-implemented method providing windows of applications running on server nodes the same look and feel as windows of applications running on a client node, and providing remote virtual desktops with the same look and feel as the local desktop on the client node, the method comprising the steps of:
(a) providing a plurality of server nodes;
(b) providing a plurality of applications running on said server nodes;
(c) providing a remote presentation protocol for accessing said applications;
(d) providing at least one client node displaying windows of said applications on a local desktop;
(e) communicating, to the server nodes, status information regarding at least one of a plurality of behavioral attributes of said local desktop, by operating at least a first software module on said client node, and
(f) receiving said status information from said client node and applying said status information to said applications running on the server nodes, by operating at least a second software module on said server nodes.
